(19) United States
(12) Patent Application Publication
(10) Pub. No.: US 2001/0029962 A1
(43) Pub. Date: Oct. 18, 2001

(54) Dental floss with combination high-strength core and wrapped sheath

(76) Inventors: Mark C. Bergman, Chino, CA (US); Richard J. Finn, Bedford, NH (US)

Correspondence Address: CISLO & THOMAS, LLP, 233 WILSHIRE BLVD, SUITE 900, SANTA MONICA, CA, 90401-1211, US

(21) Appl. No.: 09/747,127

(22) Filed: Dec. 22, 2000

Related U.S. Application Data
(60) Provisional application No. 60/171,781, filed on Dec. 22, 1999.

(51) Int. Cl. A61C 15/00

(52) U.S. Cl. 132/200; 132/321

(57) ABSTRACT

An improved dental floss is provided that has a high strength inner core and an outer tape of a relatively soft material that is wrapped around substantially the entire usable length of the core. The wraps of the outer tape may be spaced apart, or may fully cover the core, such as where the wraps of the outer tape overlap one another. The improved dental floss may also be formed by wrapping the core with a first outer tape in one direction and then with a second outer tape in a second direction. To help hold the outer tape from slipping off of, or twisting on, the core, a coating material comprising a food grade wax or other suitable material is used. Food grade mineral oil, or another suitable substance, may be added to the coating material to improve its flowability, i.e., to reduce its viscosity, in order to facilitate the coating process.

### PRIORITY

This application claims priority under 35 U.S.C. 119(e) from U.S. provisional patent application No. 60/171,781, titled DENTAL FLOSS WITH COMBINATION HIGH-STRENGTH CORE AND WRAPPED SHEATH, filed Dec. 22, 1999 and incorporated herein by reference.

### FIELD OF THE INVENTION

The present invention relates to a dental floss with a combined high-strength core and a wrapped sheath or outer layer.

### BACKGROUND OF THE INVENTION

Tooth decay and dental disease can be caused by bacterial action resulting from the formation of plaque about the teeth and/or the entrapment of food particles in interstices between the teeth. Removal of plaque and entrapped food particles reduces the incidence of caries, gingivitis, and mouth odors as well as generally improving oral hygiene. Conventional brushing has been found to be inadequate for removing all entrapped food particles and plaque. To supplement brushing, dental flosses and tapes have been recommended. Since caries typically develop on tooth surfaces where there is an accumulation of plaque, using floss to remove plaque on interproximal surfaces of teeth reduces the likelihood for the development of caries on the interproximal surfaces.

Conventional dental floss is generally made from a relatively small-diameter single elongated strand or from multiple strands twisted into a fiber having uniform dimensions. Conventional floss is not consistently effective in removing food particles and may abrade the gums as it passes between the teeth. Further, it is prone to shredding, rendering it difficult to use and not generally suitable for use in commercial flossing devices and dispensing containers.

There is a need in the art for an improved dental floss that is better able to dislodge and remove food particles trapped between the teeth. There is also a need in the art for a dental floss that does not abrade the gums, yet has a high tensile strength that resists shredding, and that may be used in commercial flossing devices such as those operating on a ratchet principle, such as in U.S. Pat. No. 5,495,863.

### SUMMARY OF THE PREFERRED EMBODIMENT(S)

The present invention features improved dental flosses and methods for manufacturing dental flosses. The novel dental floss described and claimed herein better facilitates removal of material from interproximal regions between the teeth, provides a floss that is gentle to the gums, is resistant to shredding and cut through, and that may be used in commercial flossing devices and dispensing containers.

Generally, the dental floss comprises an inner core having relatively high tensile strength, and an outer tape wrapped around the inner core. Preferably, the inner core is comprised of a relatively strong material (i.e. one of relatively high tensile strength), such as, but not limited to, polyester, polypropylene and polyethylene, and blends thereof. Other synthetic or natural fibers may also be used. The outer tape preferably comprises a relatively low strength, or soft, material, such as polytetrafluoroethylene (PTFE). The outer tape may comprise other materials and fluorocarbon polymers such as, for example, chlorotrifluoroethylene, fluorinated ethylene-propylene, polyvinylidene fluoride, hexafluoropropylene, and tetrafluoroethylene. Materials comprising PTFE have the advantage in that they are resistant to shredding. The wraps of the outer tape may be spaced apart, or may fully cover the core, such as where the wraps of the outer tape overlap one another. The combination of an inner core having relatively high tensile strength and an outer tape of relatively soft material yields a floss that is resistant to breakage and cut through, effectively dislodges particles from between the teeth, and yet slides easily between the teeth and does not abrade the gums.

The invention further features methods of making the improved flosses. A preferred method includes (a) holding a core fiber in tension; and (b) wrapping an outer tape around the inner core in an “S” direction. If desired, the inner core may then additionally be subject to a second wrapping in a “Z” direction. Preferred methods further include coating the wrapped core with a composition comprising a wax, or other suitable material, after step (b), to aid in holding the wrap onto the core. Coating with wax may also be done prior to wrapping, or in between wraps. Moreover, the coating material may be a composite of wax and mineral oil. If coating is done before applying the final wrap, it is preferred to put a binder, such as PVA, starch or wax, on the outside of the wraps to help wind the floss onto a bobbin or spool. Other features and advantages of the invention will be apparent from the drawings, the following Detailed Description, and the claims.

### BRIEF DESCRIPTION OF THE DRAWINGS

FIG. 1 is a perspective view of a strand of floss in accordance with a first embodiment of the invention;

FIG. 2 is a view similar to that of FIG. 1 but in accordance with a second embodiment;

FIG. 3 is an enlarged side view of a portion of one outer tape.

### DETAILED DESCRIPTION OF THE PREFERRED EMBODIMENTS

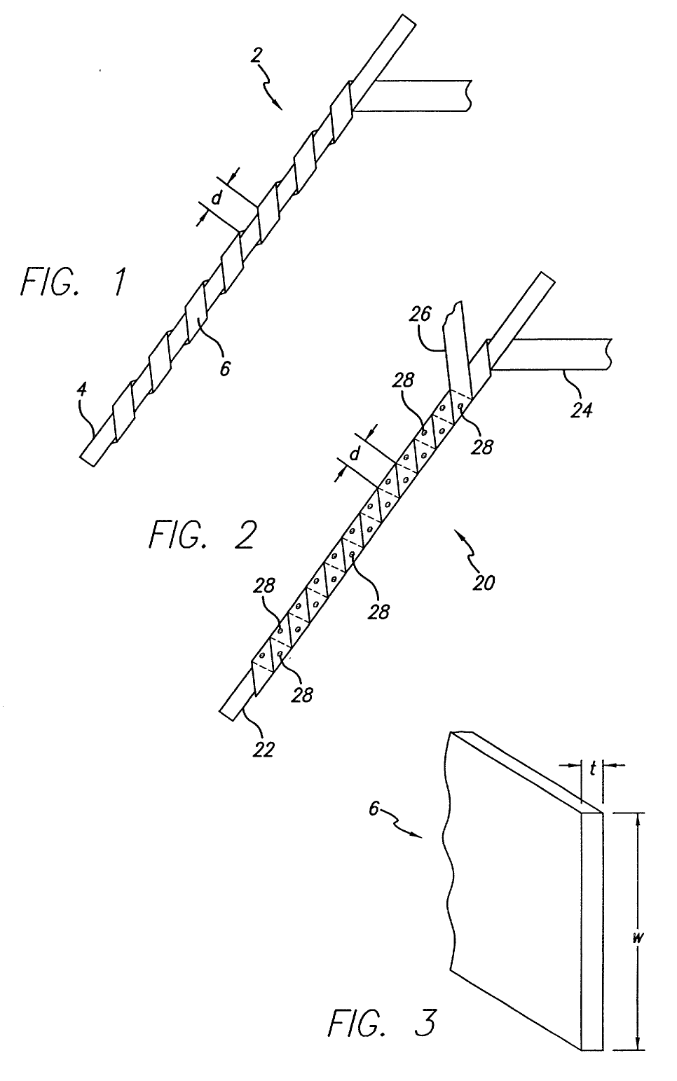

As shown in FIG. 1, a floss strand 2 in accordance with the invention has a core 4 and an outer tape 6 wrapped around it. Core 4 is preferably a strong material such as polyolefin, including polypropylene, polyethylene, copolymers and blends thereof, particularly high-strength versions. Other suitable core materials include, but are not limited to, polyamide. Materials with a breaking tenacity of about 0.4 newtons per tex (weight in grams of 10,000 meters, a unit often used in the textile industry) or 550 MPa or greater (1,000 pascals) are preferred.

The outer tape 6 is preferably comprised of a relatively low strength material such as PTFE, which may be expanded PTFE. Materials such as PTFE are preferable in that they are resistant to shredding. It is contemplated, however, that the present invention may be employed using an outer tape comprising other materials and fluorocarbon polymers such as, for example, chlorotrifluoroethylene, fluorinated ethylene-propylene, polyvinylidene fluoride, hexafluoropropylene, and tetrafluoroethylene. In this embodiment, the wraps of outer tape 6 are spaced. The distance between wraps may vary as desired or needed for a particular application. A preferred spacing is about the width w of the outer tape but closer spacing may also be desirable, including overlapping.

Because PTFE has a low coefficient of friction, it is useful for sliding between teeth. At the same time, the rougher surface of the core material and the step difference between the outer tape windings and the core material provides abrasiveness for removing plaque from teeth.

This first embodiment is a single outer tape 6 wrapped in either the “S” or “Z” direction (“S” direction shown). The outer tape 6 can fully cover the core 4, or partially cover the core 4 (partial covering shown). Also, the outer tape 6 is wrapped around substantially the entire core 4. That is, the linear length which the outer tape 6 extends along the floss, is the same, or substantially the same, as the linear length of the core 4 that will be used in the flossing procedure or that will be spooled (i.e. the “usable” length of the floss). Also, one could put two spool lengths of floss in tension and wrap the tape around one spool length, then cut one spool length, and continue wrapping. Alternately, one could just put one spool length in tension, then wrap, then cut, or other variations thereof.

For certain materials, e.g., polyamides such as NYLON, a registered trademark of E.I. du Pont de Nemours & Co. (“du Pont”) of Wilmington, Del., one would prefer an exposed core to use the plaque-removal ability of NYLON. For other materials, such as polyolefins or para-aramids (e.g., KEVLAR, a registered trademark of du Pont), full coverage is preferred.

In the second embodiment, shown in FIG. 2, a floss strand 20 is formed by a core 22 and two PTFE tapes 24, 26. Core 22 may be made of any of the same materials and have the same properties as core 4 of FIG. 1. The difference between this embodiment and that of FIG. 1 is that one outer tape, e.g., outer tape 24, is first wrapped around the core 22 in one direction. Then, the other outer tape 26 is wrapped around the core 22 in the other direction. Outer tape 26 is preferably wound so as to cover the gaps between wraps of outer tape 24. The first outer tape 24 may be referred to as an “S” tape or “S” wrapping pattern and the second outer tape 26 may be referred to as the “Z” tape or “Z” wrapping pattern. The space between wraps of the S and Z outer tape are preferably the same, which may be the same as distance d of FIG. 1 or both the S and Z tape may have complete coverage. This distance can be varied and may also result in an overlap of about one third to about one half of the width w of the outer tape 6, 24, 26. Double covering (the S and Z outer tapes each providing full coverage) as shown in FIG. 2 is done to assure full coverage and better stability. More layers may be used.

It is important to understand that both embodiments are formed by wrapping the PTFE outer tape(s) 6, 24, 26 around the core 4, 22 along substantially the entire usable length of the floss, or around substantially the entire length of the portion of the floss that will be wound onto a bobbin or into a spool. Generally, the outer tape(s) and core are not twisted although they could be twisted. The resultant floss strand 2, 20 may be waxed or unwaxed.

The embodiments of FIGS. 1 and 2 may also be formed by wrapping each wind of the outer tape 6, 24, 26 with an overlap, e.g., for FIG. 1, outer tape 6 could be wrapped such that each winding overlaps the previous winding, preferably by about one third to one half the width w of the outer tape 6.

Typical dimensions of the PTFE forming the outer tape 6, 24, 26 are about 0.001 inch thick and about 0.070 inch wide. However, in the present invention, the preferred thickness t of the PTFE forming the outer tape 6, 24, 26 is 0.001 inch-0.0025 inch, or about 200 to about 600 denier. Denier is the weight in grams of 9000 meters and is used in textile production. The preferred range of width w of the PTFE outer tape is 0.060 inch-0.080 inch. The core material is preferably about 70 to 300 denier. Larger sizes of the core and/or outer tape material may be used, but at the point where the floss will not fit between teeth, it is too thick.

An advantage of the invention is that it takes a low strength flossing material, such as PTFE, and a high-strength core to achieve a floss of high tensile strength with a soft outer wrap. The material is particularly suitable for use in a flossing device such as in U.S. Pat. No. 5,495,863 issued Mar. 5, 1996 to Mark C. Bergman, incorporated by reference herein. Such a flossing device works on a ratchet principle and thus requires a floss of high strength, particularly high resistance to cut through, and a suitable tensile strength. PTFE is a desirable floss material that would not be suitable for such a high-strength application. Moreover, if twisted with another material it would be thick and have a round cross-section.

A method of producing the high-strength floss in accordance with the present invention includes the following steps:

The core 4, 22 is held tightly in tension. The PTFE outer tape 6, 24 is wrapped in the S direction. If greater or thicker coverage of the core is desired, a second outer tape 26 is wrapped in the Z direction. The wraps extend for the entire length, or substantially the entire length, of the core 4, 22, or at least the usable length of the core. Also, one could put two spool lengths of floss in tension and wrap the tape around one spool length, then cut one spool length, and continue wrapping. Alternately, one could just put one spool length in tension, then wrap, then cut, or other variations thereof.

To help hold the outer tape from slipping off of, or twisting on, the core, a coating material comprising a food grade wax or other suitable material may be used. For example, the coating material may comprise carnauba, natural beeswax, petroleum wax or oxidized polyetbylene. That is, the core or the resulting PTFE wrapped core 4, 22 would be dipped in, impregnated with, or otherwise have applied, the coating material, if desired.

Food grade mineral oil, or another suitable substance, may be added to the coating material to improve its flowability, i.e., to reduce its viscosity, in order to facilitate the coating process. The amount of mineral oil added should be adequate to provide a decrease in viscosity of the wax or coating material, but not so much that it looses its tackiness and becomes too liquid. For example, an amount of mineral oil between 0.01% to 20% or more, by weight or volume, may be used depending upon the type of wax used, the desired amount of viscosity, and other factors evident to those skilled in the art.

Dental floss is commonly wound onto a bobbin, or into a spool, for use in commercial dispensing containers or in hand-held flossing devices. To facilitate in the spooling process, a material imparting tackiness 28 may be applied to the dental floss once it is fully wrapped. For example, a material comprising food grade starch, polyvinyl acetate (PVA), wax, or other tacky but non-toxic substance, may be applied to the exterior of the floss to facilitate the process of winding the floss onto a bobbin or into a spool, to be used, for example, with the invention of the above-mentioned Bergman patent. Preferably, the material imparting tackiness 28 is applied in a dotted fashion, or otherwise evenly spread, on the outer surface of the floss in order to impart sufficient tackiness to aid in the spooling process.

Where the floss is used in the invention of the above-mentioned Bergman patent, it is then wound into a spool, or on a bobbin. The core 4, 22 may have a round, oval or other cross-sectional shape as desired. The outer tape 6, 24, 26 preferably has a flat or substantially flat shape for wrapping purposes, and for helping to maintain an overall cross-sectional size comparable to existing floss materials so as to be acceptable for flossing and for use in commercial flossing devices and dispensing containers.

While what has been described above is the preferred embodiment of the invention, it will be appreciated that those skilled in the art may make numerous changes without departing from the spirit or scope of the invention. The invention is not limited to the disclosed embodiments, but is defined by the appended claims.

I claim:

1. A dental floss comprising:
(a) a core, and
(b) at least one outer tape, wherein
the outer tape is wrapped around the core and forms a plurality of wraps along substantially the entire usable length of the core.

2. The dental floss of claim 1 wherein the core comprises a relatively high tensile strength material in relation to the outer tape.

3. The dental floss of claim 1 wherein the core comprises a material having a breaking tenacity of at least about 0.4 newtons per tex or greater.

4. The dental floss of claim 1 wherein the outer tape comprises polytetrafluoroethylene (PTFE).

5. The dental floss of claim 1 wherein the wraps are spaced apart.

6. The dental floss of claim 5 wherein the wraps are spaced apart by a distance that is approximately equal to the width of the outer tape.

7. The dental floss of claim 1 wherein there are two wraps, and the wraps overlap thereby forming an overlap.

8. The dental floss of claim 7 wherein the overlap is approximately one third to one half the width of the outer tape.

9. The dental floss of claim 1 wherein the outer tape has a thickness that is approximately 0.001 to approximately 0.0025 inch.

10. The dental floss of claim 1 wherein the outer tape has a width that is approximately 0.060 to approximately 0.080 inch.

11. The dental floss of claim 1, wherein the core comprises a material selected from the group consisting of polyolefin, polypropylene, polyethylene and polyamide.

12. A dental floss comprising:
(a) a core;
(b) at least a first and a second outer tape wrapped along substantially the entire usable length of the core, wherein the first outer tape is wrapped in an “S” direction along substantially the entire usable length of the core, thereby forming “S” wraps, and the second outer tape is wrapped in a “Z” direction along substantially the entire usable length of the core, thereby forming “Z” wraps, wherein the core comprises a relatively high tensile strength material in relation to the outer tape.

13. The dental floss of claim 12 wherein a first distance between the “Z” wraps and a second distance between the “S” wraps are approximately equal.

14. The dental floss of claim 12 wherein the “Z” wraps are disposed in gaps between the “S” wraps.

15. The dental floss of claim 12 wherein at least one of the “S” and “Z” wraps completely cover the core.

16. A method of producing dental floss, comprising:
(a) holding a core in tension; and
(b) wrapping a first outer tape around the core in a first direction along substantially the entire usable length of the core.

17. The method of claim 16 further comprising the step of wrapping a second outer tape in a second direction around the core along substantially the entire usable length of the core.

18. The method of claim 16 further comprising the step of coating the core with a wax.

19. The method of claim 16 further comprising a step of mixing a wax with a food grade oil and coating at least one of the core and dental floss with the oil and wax mixture.

20. The method of claim 16 further comprising the step for imparting tackiness to a surface of the dental floss by applying a food grade material to the surface.

21. The method of claim 16 further comprising the steps of cutting a predetermined length of the floss and then continuing wrapping the first outer tape around the core.

22. A dental floss for winding into a spool or bobbin of a predetermined length, the floss comprising:
(a) a core having a predetermined length;
(b) at least one outer layer wrapped around the core for substantially the predetermined length; and
(c) means for holding the wrapped outer layer on the core.

22. The dental floss of claim 21 wherein the core comprises relatively high strength material in relation to the outer layer, and the outer layer comprises a relatively low friction material in relation to the core.
